(19) United States
(12) Patent Application Publication
(10) Pub. No.: US 2018/0322510 A1
(43) Pub. Date: Nov. 8, 2018

(54) VISUALIZATION AND EVALUATION OF CAPABILITIES AND COMPLIANCE FOR INFORMATION TECHNOLOGY PLATFORMS

(71) Applicant: International Business Machines Corporation, Armonk, NY (US)

(72) Inventors: James D. Cleaver, Sydney (AU); Sean R. Costello, Sydney (AU); Stefan Harrer, Hampton (AU); Laurence J. Plant, North Balwyn (AU)

(21) Appl. No.: 15/586,330

(22) Filed: May 4, 2017

(51) Int. Cl. G06Q 30/00; G06Q 10/06; G06F 17/27

(52) U.S. Cl. CPC G06Q 30/018; G06F 17/2785; G06Q 10/067

(57) ABSTRACT

A system, method and program product for evaluating IT platforms such as hybrid clouds and edge platforms. A system is disclosed that includes an ingestion engine that utilizes natural language processing to capture capabilities associated with a set of platforms; a modeling system for storing capabilities in a structured model that includes a set of IT categories and a set of IT features in each IT category; an analysis system that generates a compliance analysis by evaluating policies and requirements of an enterprise against capabilities stored in the structured model; and a visualization system that generates a graphical view of the IT categories and IT features, wherein the graphical view further includes a visualization of the compliance analysis.

### TECHNICAL FIELD

The subject matter of this invention relates to information technology capabilities and compliance management, and more particularly to a system for evaluating and visualizing capabilities and compliance for hybrid cloud and edge platforms.

### BACKGROUND

In order to reduce information technology (IT) costs and increase speed of development and delivery, enterprises (e.g., businesses and other organizations) are moving from owning and operating their own data centers to using shared capabilities such as Software as a Service (SaaS) or Infrastructure as a Service (IaaS) platforms from third party cloud service providers. This approach typically results in a hybrid cloud model where the enterprise has its portfolio of applications and data spread across internal IT systems and external cloud environments provided by one or more third party cloud service providers.

However, as enterprises pass operational responsibility to cloud service providers, the enterprise still carries risk if the cloud service fails, is breached, or does not adhere to relevant regulatory and industry compliance standards which vary by industry and geography. One challenge for many enterprises is that it is becoming more and more complicated to understand and monitor service definition and risk, e.g., what is being provided externally by each cloud service provider versus internally by the business itself, what is the responsibility of each cloud service provider versus the business, what is being overlooked, how is each facet monitored and independently audited, etc.

Accordingly, as an enterprise uses an increasing number of cloud platforms, the enterprise could be exposed to increasing operational risk and increasing risk of not meeting regulatory requirements. This can result when key information about each cloud platform is not properly monitored, understood or addressed. Today, cloud providers seek to have their platforms comply with different standards, frameworks and guidelines (e.g., ISO, PCI, IRAP, MPAA) and this compliance is reviewed by the standards or framework body itself, or by an independent third party auditor. It is then up to each enterprise to understand the cloud capabilities including risk and compliance of each vendor they are using or considering using, which is a complex analytical effort undertaken by subject matter experts within the enterprise over an extended period of time. The time and effort required for an enterprise to understand and audit a cloud platform and understand changes to capabilities and compliance and risk over time is an impediment to cloud adoption and market competition. For example, given the costs involved, once the due diligence of evaluating one cloud platform has been undertaken, a business is unlikely to duplicate that effort of evaluating a competing cloud platform.

The problem becomes even more complex when dealing with logic and data on edge platforms (such as smartphones, tablets, set top boxes, gateways, embedded systems, etc.), which can involve numerous heterogeneous systems. Monitoring services and managing risk on multiple edge platforms can become an overwhelming task.

### SUMMARY

Aspects of the disclosure provide a system and process for evaluating and visualizing capabilities and compliance for hybrid cloud and edge platforms. This approach allows an enterprise to better manage these complex IT environments, including: more effectively handling the case where a cloud service provider fails a security audit; comparing the data retention and backup policies of different cloud platforms; if a business is responsible for data in the cloud, determining what options exist for the business to manage data (e.g., encrypt and anonymize data, backup and restore data, etc.); identifying gaps where the cloud provider does not have capabilities, and identifying tools available from the market to address the gaps; comparing solutions from competing vendors and open source; comparing the service level agreements of different cloud platforms; comparing performance metrics such as availability over time, automatically being notified when cloud platform capabilities and compliance changes over time to ensure ongoing governance, etc.

A first aspect discloses a system for evaluating information technology (IT) platforms, including: an ingestion engine that utilizes natural language processing to capture capabilities associated with a set of platforms; a modeling system for storing capabilities in a predefined model that includes a set of IT categories and a set of IT features in each IT category; an analysis system that generates a compliance analysis by evaluating policies and requirements of an enterprise against capabilities stored in the predefined model; and a visualization system that generates a graphical view of the IT categories and IT features, wherein the graphical view further includes a visualization of the compliance analysis.

A second aspect discloses a computer program product stored on a computer readable storage medium, which when executed by a computing system, evaluates information technology (IT) platforms, the program product including: program code that utilizes natural language processing to capture capabilities associated with a set of platforms; program code for storing capabilities in a predefined model that includes a set of IT categories and a set of IT features in each IT category; program code that generates a compliance analysis by evaluating policies and requirements of an enterprise against capabilities stored in the predefined model; and program code that generates a graphical view of the IT categories and IT features, wherein the graphical view further includes a visualization of the compliance analysis.

A third aspect discloses a computerized method that evaluates information technology (IT) platforms, comprising: utilizing natural language processing to capture capabilities associated with a set of platforms; storing capabilities in a predefined model that includes a set of IT categories and a set of IT features in each IT category; generating a compliance analysis by evaluating policies and requirements of an enterprise against capabilities stored in the predefined model; and generating a graphical view of the IT categories and IT features, wherein the graphical view further includes a visualization of the compliance analysis.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system of an IT evaluation system according to embodiments.

FIG. 2 shows an illustrative visualization of a runtime environment according to embodiments.

FIG. 3 shows an illustrative visualization of a cloud platform according to embodiments.

FIG. 4 shows an illustrative visualization of an edge platform according to embodiments.

FIG. 5 shows an illustrative visualization of a hybrid cloud according to embodiments.

FIG. 6 shows flow diagram of a process for analyzing capabilities and compliance of platforms according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

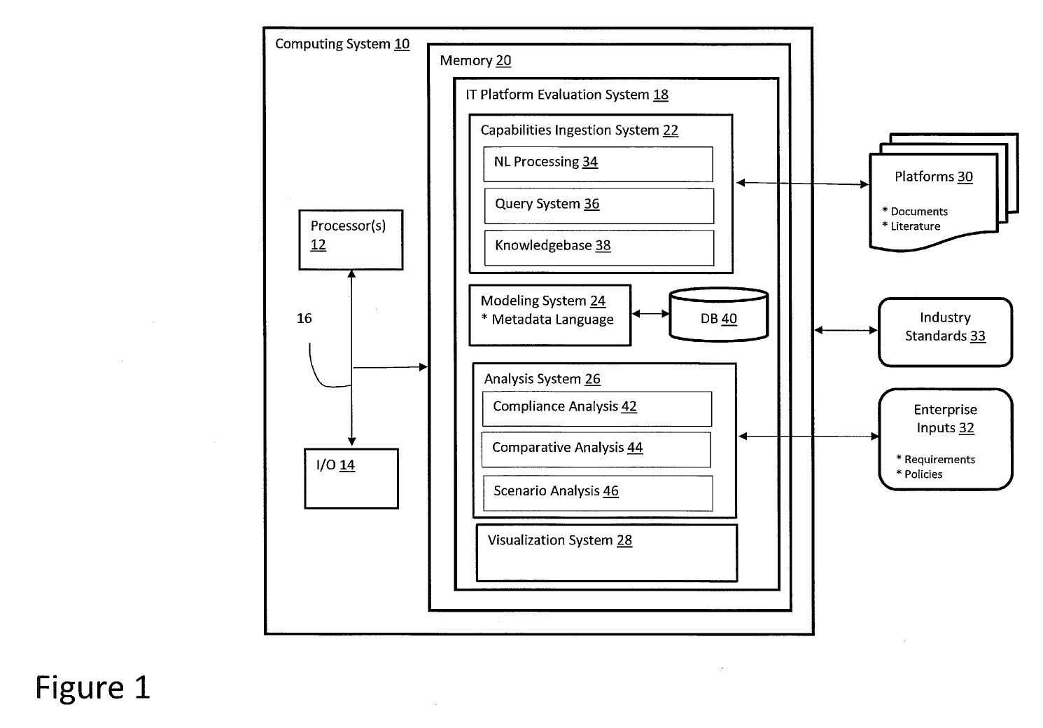

Referring now to the drawings, FIG. 1 depicts a computing system 10 having an IT platform evaluation system 18 that, among other things, provides a cognitive solution for aiding in the governance of enterprise IT security and compliance (“compliance”) of platforms 30. As described in further detail herein, IT platform evaluation system 18 analyzes documents and other inputs to produce a visualization that details whether a given platform or set of platforms 30 utilized by an enterprise comply with necessary requirements and policies, and what issues or risks exist. For the purposes of this disclosure, each platform 30 may include any environment that is currently in use or under consideration for use by the enterprise to run workloads and/or store data, including, e.g., on premise data centers, cloud service provider services including edge platforms, etc.

Cloud platforms generally comprise Information and Communication Technology (ICT) services and infrastructure and may for example include Infrastructure as a Service (IaaS) including virtual machines on bare metal, Platform as a Service (PaaS) including integration platforms, Software as a Service (SaaS) including hosted applications, services deployed into a customer's environment, services deployed on infrastructures dedicated to a client in a data center environment shared between clients, services deployed on infrastructures shared by multiple clients in a data center environment shared between clients, etc.

Edge platforms generally refer to compute platforms outside a data center and include consumer electronics devices (e.g., smartphones, smart devices, Internet of Things devices, tablets, Set Top Boxes, etc.), network equipment (e.g., customer premise equipment such as gateways and telco service provider environment such as access network equipment), industrial or OEM equipment such as embedded systems and vehicle telematics systems, etc. Common operating systems for edge platforms include iOS, Android, Windows and Linux. Application (app) stores exist for popular consumer edge platforms (e.g., iOS and Android) and these app stores manage code review, shopping, purchase, charging, distribution, provisioning, and maintenance. Each edge platform generally has its own system of management and each edge platform may or may not comply with industry regulations.

IT platform evaluation system 18 generally includes: a capabilities ingestion system 22 that captures capabilities information associated with each of the platforms 30; a modeling system 24 that stores the capabilities information in a predefined model; an analysis system 26 that analyzes capabilities information; and a visualization system 28 that provide a visual output that shows compliance analysis for different aspects of one or more platforms 30.

Capabilities ingestion system 22 may utilize any mechanism for collecting structured and/or unstructured capabilities information. In one illustrative embodiment, documents and other literature associated with a platform 30 are identified and inputted using natural language (NL) processing 34. Illustrative documents may for example include enterprise IT policies such as security standards and industry compliance regimes, e.g., Payment Card Industry (PCI) Data Security Standard. Other examples may include descriptions of the architecture, third party audit reports of each platform 30, general information collected on the Web, etc.

For instance, Amazon Web Services (AWS™) provides an online resource detailing compliance information, see https://aws.amazon.com/compliance/. Utilizing NL processing, the unstructured information on the webpage(s) would be analyzed and captured into a structured format. For example, one of the webpages indicates that AWS is certified under ISO 27001 for security management, which for example could be temporarily stored by the ingestion engine in data structure, e.g., <Security Management>=“ISO 27001”.

In further embodiments, capabilities information may be gathered with a query system 36 that, e.g., queries a subject matter expert for information. The query system 36 may for example generate a series of automated emails to one or more people to obtain information. In addition, a knowledgebase 38 may be maintained with capabilities information for commonly used platforms 30 (e.g., large cloud service providers).

Capabilities information may for example include: the physical infrastructure of the platform 30 including, e.g., geographical location, the premises, and hardware specifications such as servers, storage and network equipment; software infrastructure of the platform 30, including the full stack from virtual servers, virtual storage and virtual networks through hypervisors, operating systems, middleware up to applications and data; system management including a full set of designs, procedures, functions, commitments and tools the service provider applies to keep the physical and software infrastructure in production and compliant with regulatory requirements (examples of management capability domains include Service Development, Service Transition, Virtual Infrastructure Management, Physical Infrastructure Management, Data Management, etc.; and regulatory requirements, which can differ by industry and include compliance regimes such as APRA, SOC 2, ISO27000, etc.).

Ingested capabilities information is formatted by modeling system 24 in a common language and then stored in database (DB) 40. Modeling system 24 may comprise any mechanism for processing storing capabilities information in a structured format or model, such as a metadata language. The model may for example represent an architecture of a given platform 30, an auditor's view of the platform 30 and include compliance requirements, an enterprise's view of the platform 30 and include security and compliance issues, etc. Different predefined models may be utilized for different type of platforms (e.g., cloud platforms versus edge platforms).

In one illustrative embodiment, capabilities information may be modeled in a mark-up language such as the following:

```
<Platform Name> XYZ Cloud Provided
    <Software Infrastructure>
        <Type> SaaS
            <Feature.1> Analytics = “analytics type”
            <Feature.2> Logs = “Ascii Logs”
            <Feature.3> Application Server = “VM System”
            ...
    <Physical Infrastructure>
            <Feature.1> CPU = “CPU type”
                <location> Paris, FR
            <Feature.2> Storage = “Storage type”
            <Feature.3> Network = “Internet”
            ...
    <Systems Management>
            <Feature.1> Finance = “yes”
            <Feature.2> SLA = “yes”
            <Feature.3> Compliance Reporting = “optional”
            ...
    <Service Operations>
            <Feature.1> Service Desk = “yes”
            <Feature.2> Event Management = “no”
            <Feature.3> Availability Monitoring = “optional”
            ...
    <Security Management> ...
    <Data Management> ...
    <Compliance> ...
    <Service Development> ...
    <Service Transition> ...
    <Virtual Infrastructure Management>
    <Physical Infrastructure Management>
    <Remote Endpoint Management>
    ...
```

In this example, capabilities are broken out into various IT categories/subcategories (e.g., systems management, service operations, etc.), and then IT features or elements of each category are provided along with a value (e.g., yes/no, optional, type, amount, etc.) captured by the capabilities ingestion system 22. The resulting completed (or semi-completed) model for each platform is stored in database 40. It is understood that the above example is intended to provide an illustrative embodiment, and may include more complete and/or different types of information.

Once compliance information is stored in one or more structured models, analysis system 26 then analyzes the generated models to provide various types of analysis information. For example, analysis system 26 may collect enterprise inputs 32, such as requirements and policies of the enterprise and then generate a compliance analysis 42 to determine which IT categories and/or features of the enterprise are in or not in compliance. For example, the enterprise may require that that the security management is certified as ISO 27001 compliant. Analysis system 26 would analyze data from the model to determine if the platform complies with the standard.

Similarly, industry standards 33 may be collected and analyzed as part of the compliance analysis. For example, for a particular industry, it may be required that data is stored within the country. If a cloud platform is configured to store data across several countries, then the compliance analysis 42 would indicate that the “physical storage” feature has a compliance issue. Further, compliance analysis 42 may integrate information from multiple platforms 30 to provide a comprehensive compliance analysis of the entire enterprise.

Comparative analysis 44 may be generated by the enterprise to compare different or competing platforms 30 on a category and/or feature basis. Using the comparative analysis 44, capabilities and/or compliance information of competing platforms 30 can be visually presented to the enterprise for decision making purposes.

Scenario analysis 46 may be generated to analyze “what-if” type scenarios. For example, if the enterprise were to add a third party data encryption solution, what compliance issues would be solved and what issues would be created? In a further example, how would availability and risk be impacted if a change in cloud provider is made?

Once the analysis is generated, the analysis information can be displayed to the enterprise via visualization system 28. Visualization system 28 generates a graphical view of each IT category and associated IT features of one or more platforms 30, and incorporates a visual depiction of the associated capabilities analysis.

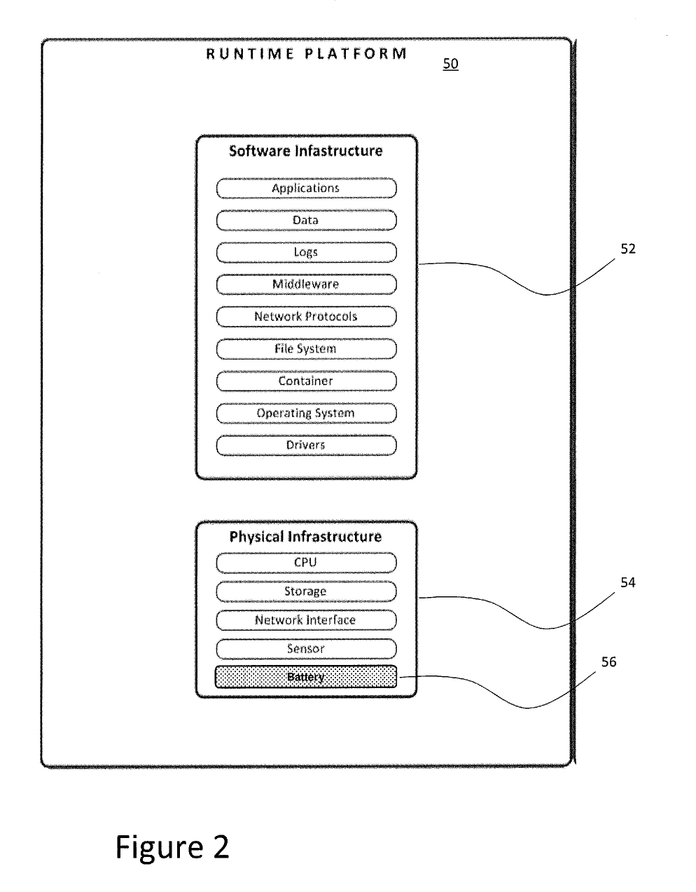

For example, FIG. 2 depicts a basic runtime platform 50 visualization that depicts a software infrastructure category 52 and a physical infrastructure category 54. In this case, the feature “Battery” is highlighted, indicating a compliance issue. Alternatively, color coding (not shown) could be utilized to identify features not in compliance. In one illustrative embodiment, the user could click on any one of the categories or features to display more detailed compliance information (not shown). For example, clicking on the Battery feature could pull up a window explaining why the feature is not in compliance.

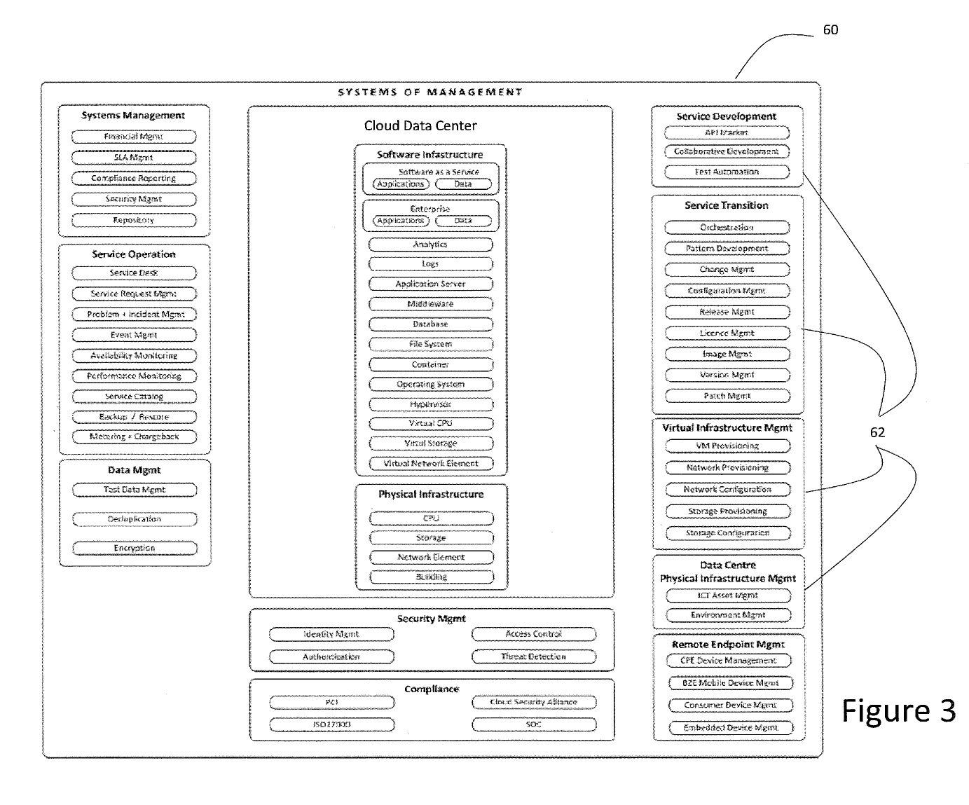

FIG. 3 depicts a more involved visualization of a cloud data center 60. In this case, the visualization includes numerous IT categories 62 and features. For example, displayed categories 62 may include software infrastructure, physical infrastructure, systems management, service operation, data management, service development, service transition, virtual infrastructure management, data center physical infrastructure management, remote endpoint management, security management, and compliance. Each of the displayed IT categories likewise include associated features. Although not shown in this example, one or more of the categories and/or features would be highlighted or color coded to depict a compliance analysis 42.

Alternatively, two versions of the visualization could be generated or overlaid for competing platforms. In that case, a comparative analysis 44 (e.g., capabilities, compliance, etc.) could be depicted in each.

Still further, an interface may be provided to the user to enter potential “what-if” criteria (e.g., what if we installed a third party encryption tool?). The resulting scenario analysis 46 would be displayed on the visualization, e.g., features may change colors from red to green indicating that compliance would be met, etc.

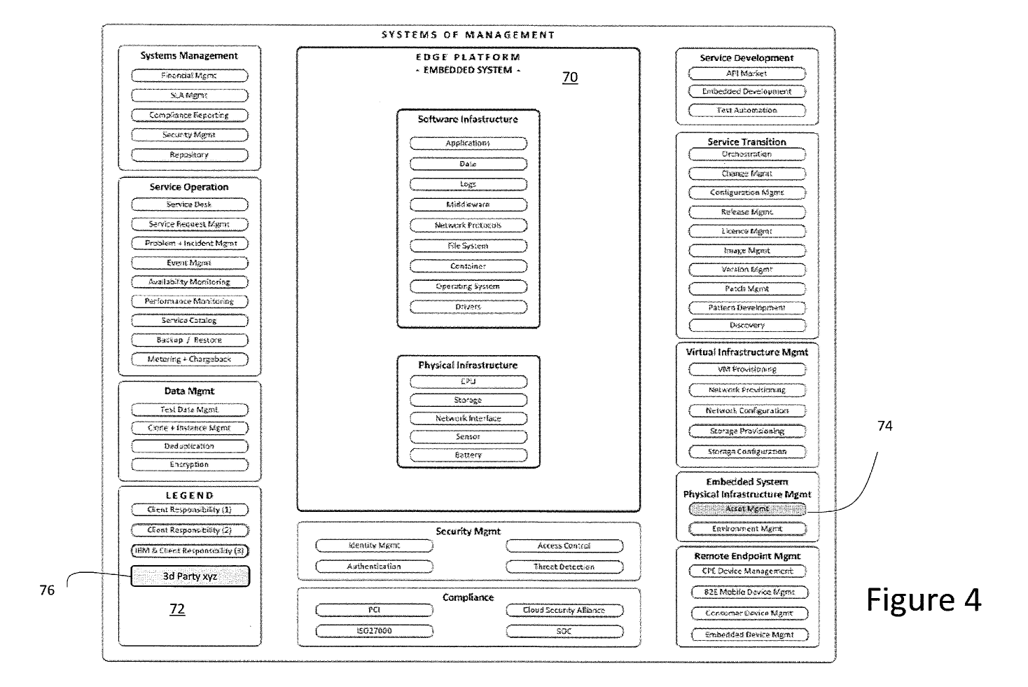

FIG. 4 depicts an example of an edge platform 70 visualization. In this case, a legend 72 is provided that includes several “responsible entities,” which are color coded (not shown). The user can then easily see which entity is responsible for which features and/or categories. For example, 3d Party xyz 76 is responsible for asset management 74. Clicking on an entity, feature or category could bring up associated capabilities or compliance information.

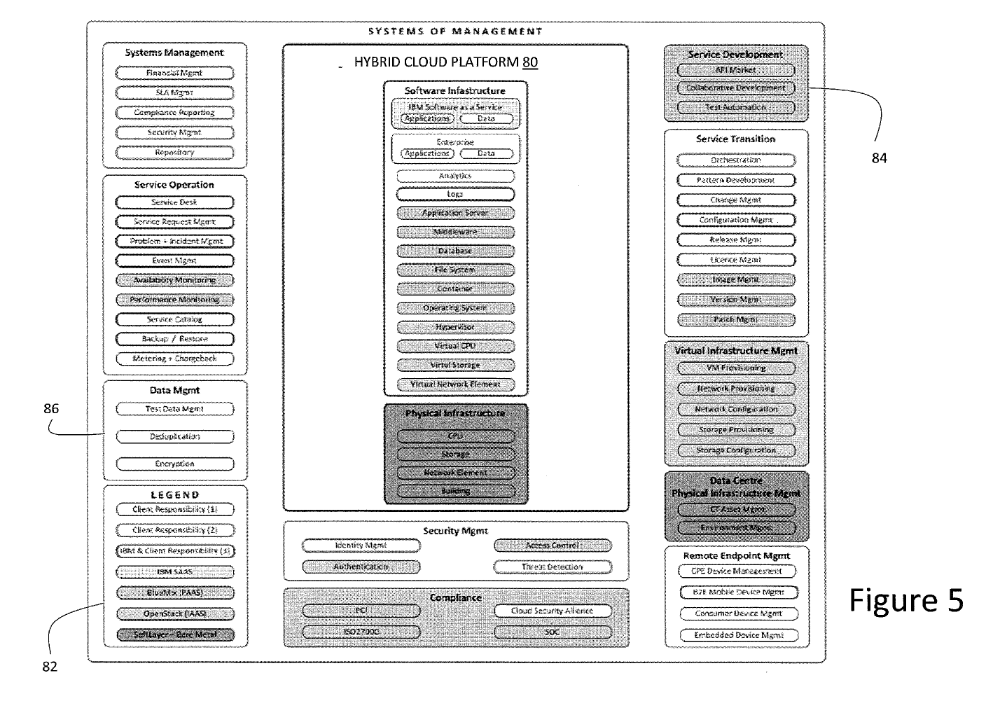

FIG. 5 depicts an example of a hybrid cloud platform 80 visualization. This visualization likewise includes a legend 82 that dictates who is responsible for which IT category and/or feature. For example, data management 86 has a first color coding indicating that it falls under responsibility of the client, while service deployment is managed by a third party provider. It is understood that the particular visualization formats shown are for illustrative purposes only, and the particular view, color coding, highlighting, presentation, etc., can vary based on the implementation.

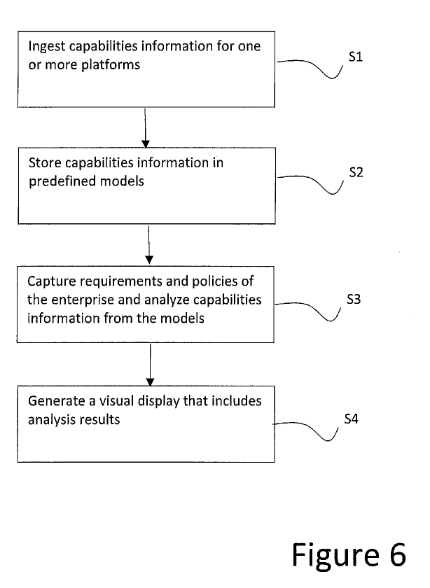

FIG. 6 depicts a flow diagram of a process for implementing the IT platform evaluation system 18 (FIG. 1) for an enterprise. At S1, capabilities information for one or more platforms utilized by the enterprise are ingested, e.g., using NL processing. At S2, the capabilities for each platform are stored in a structured model. At S3, requirements and policies of the enterprise are captured and analyzed along with the structured capabilities information to generate analysis results, e.g., compliance analysis. At S4, a visual display of the platform(s) are displayed along with the analysis results.

It is understood that IT platform evaluation system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 20, an input/output (I/O) 14 (e.g., one or more I/O interfaces and/or devices), and a communications pathway 16. In general, processor(s) 12 execute program code which is at least partially fixed in memory 20. While executing program code, processor(s) 12 can process data, which can result in reading and/or writing transformed data from/to memory and/or I/O 14 for further processing. The pathway 20 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the IT platform evaluation system 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for evaluating information technology (IT) platforms, comprising:
an ingestion engine that utilizes natural language processing to capture capabilities associated with a set of platforms;
a modeling system for storing capabilities in a structured model that includes a set of IT categories and a set of IT features in each IT category;
an analysis system that generates a compliance analysis by evaluating policies and requirements of an enterprise against capabilities stored in the structured model; and
a visualization system that generates a graphical view of the IT categories and IT features, wherein the graphical view further includes a visualization of the compliance analysis.

2. The system of claim 1, wherein the ingestion engine processes at least one of product literature, third party audit reports and security and compliance standards.

3. The system of claim 1, wherein the set of platforms include at least one of a cloud platform and an edge platform.

4. The system of claim 1, wherein the analysis system further generates a comparative analysis by evaluating capabilities of competing platforms.

5. The system of claim 1, wherein the analysis system further generates a scenario analysis.

6. The system of claim 1, wherein the visualization system utilizes one of highlighting and color coding to depict compliance issues.

7. The system of claim 1, wherein the visualization system utilizes color coding to depict which of a group of responsible entities fulfill different IT categories and IT features.

8. A computer program product stored on a computer readable storage medium, which when executed by a computing system, evaluates information technology (IT) platforms, the program product comprising:
program code that utilizes natural language processing to capture capabilities associated with a set of platforms;
program code for storing capabilities in a structured model that includes a set of IT categories and a set of IT features in each IT category;
program code that generates a compliance analysis by evaluating policies and requirements of an enterprise against capabilities stored in the structured model; and
program code that generates a graphical view of the IT categories and IT features, wherein the graphical view further includes a visualization of the compliance analysis.

9. The program product of claim 8, wherein the natural language processing processes at least one of product literature, third party audit reports and security and compliance standards.

10. The program product of claim 8, wherein the set of platforms include at least one of a cloud platform and an edge platform.

11. The program product of claim 8, further comprising program code that generates a comparative analysis by evaluating capabilities of competing platforms.

12. The program product of claim 8, further comprising program code that generates a scenario analysis.

13. The program product of claim 8, wherein the visualization utilizes one of highlighting and color coding to depict compliance issues.

14. The program product of claim 8, wherein the visualization utilizes color coding to depict which of a group of responsible entities fulfill different IT categories and IT features.

15. A computerized method that evaluates information technology (IT) platforms, comprising:
utilizing natural language processing to capture capabilities associated with a set of platforms;
storing capabilities in a structured model that includes a set of IT categories and a set of IT features in each IT category;
generating a compliance analysis by evaluating policies and requirements of an enterprise against capabilities stored in the structured model; and
generating a graphical view of the IT categories and IT features, wherein the graphical view further includes a visualization of the compliance analysis.

16. The method of claim 15, wherein the natural language processing processes at least one of product literature, third party audit reports and security and compliance standards.

17. The method of claim 15, wherein the set of platforms include at least one of a cloud platform and an edge platform.

18. The method of claim 15, further comprising generating a comparative analysis by evaluating capabilities of competing platforms.

19. The method of claim 15, further comprising generating a scenario analysis.

20. The method of claim 15, wherein the visualization utilizes one of highlighting and color coding to depict compliance issues.
